(19) United States
(12) Patent Application Publication
(10) Pub. No.: US 2015/0269945 A1
(43) Pub. Date: Sep. 24, 2015

(54) VOICE-KEY ELECTRONIC COMMERCE

(71) Applicants: Thomas Jason Taylor, San Clemente, CA (US); Reyhan Nihat Pasinli, Aliso Viejo, CA (US)

(72) Inventors: Thomas Jason Taylor, San Clemente, CA (US); Reyhan Nihat Pasinli, Aliso Viejo, CA (US)

(21) Appl. No.: 14/223,678

(22) Filed: Mar. 24, 2014

(51) Int. Cl. G10L 17/24; G06Q 30/06

(52) U.S. Cl. CPC G10L 17/24; G06Q 30/0601

(57) ABSTRACT

A voice checkout system and method for electronic commerce uses a webpage module to activate a customer's microphone. A recording of a verbal identity code candidate is submitted by a portal to a biometric voiceprint engine which identifies the correct words and vocal patterns of the customer and returns to the seller the information that the transaction is verified. The system includes security features to verify that recording is not used, that the words of the voiceprint are not being spoken by a different party and so on.

### FIELD OF THE INVENTION

This invention relates generally to speech signal processing, in particular applications to security systems such as may be found in class 704, subclass 273.

### STATEMENT REGARDING FEDERALLY FUNDED RESEARCH

This invention was not made under contract with an agency of the U.S. Government, nor by any agency of the U.S. Government.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND

Modern ecommerce requires secure methods of facilitating payment for goods and services purchased electronically.

In most instances, a customer accesses a network such as the Internet by means of an electronic browsing device such as a computer or telephone. The customer's first transaction requires that they deposit with the retailer their personal financial information such as credit card number, address for physical shipment of the products or performance of the service, and so on.

More recently, intermediary services have sprung up which hold the customer's financial information. When a purchase is made, the retailer's webpage offers to the customer the option of using the intermediary service PAYPAL® being the most noticeable example) to complete the transaction, that is, to make the payment. This serves several purposes. It allows the customer to input their information into only a single electronic web service, thus reducing the number of times that information is transmitted and the chances of the information being compromised. It allows the retailer to avoid having to gather and safeguard that information.

Significantly, it also renders online commercial activity much faster and more convenient to carry out. This ease of use is very important in online sales, which tend to be made on a more impulse oriented basis than most brick-and-mortar sales.

Usually such services are accessed also through the medium of a webpage, that is, the option to use the intermediary payment service is offered by means of a virtual button or the like. Such buttons are in fact merely part of the HTML/XML/XHTML/JAVA coding of most webpages, with plug-ins or modules which are also supported by standards on both the client side and the server side, such as PHP, ASP.net, HTML5, FLASH, Silverlight, and of course other parts of such a system including operating systems, iOS, Android and the like. The intermediary makes the code for the button module available to the retailer, who incorporates it into their webpage. The webpage itself is normally merely an elaborate coding in HTML/XML/XHTML/JAVA, so this is an extremely easy task to carry out on the part of the retailer's technical staff.

However, whether checkout is by intermediary or directly, it will nonetheless require the user to log in at least once to whichever entity is going to receive and hold the customer's financial data. Thus a customer pushing a ‘PAY USING PAYPAL®’ button will then normally be required to type into their computer their password for that service. While such passwords, especially if the password chosen is simple, may be easier to remember than a credit card number, it is nonetheless more mental clutter for internet shoppers and thus it presents another time barrier to retailers making purchases. In addition, increasingly customers will be accessing websites by means of extremely small and portable devices which may feature tiny keyboards, tiny on-screen keyboards for touch screens, or even no keyboard at all. This slows down the customer even further at a moment when the retailer wants everything to be extremely convenient and quick.

It would be preferable to provide a method and device which allows customers to check out via voice recognition technology.

It would be preferable to provide a voice checkout capability which does not require the customer to use a special set-top box, a specially downloaded piece of software, or any other specialized voice payment module.

It would further be preferable to not merely test the candidate voice identification on a pass-fail basis but to gather information which might be useful to detect fraud and provide information as to the probable nature of the fraud: use of tape recordings, interception of pass phrase words by individuals other than the customer, or simply forgetfulness of the customer as to what their pass phrase words actually are.

### SUMMARY OF THE INVENTION

The present invention teaches a system and method in which an electronic voice-key portal offers retailers the ability to embed within normal webpage protocols an option for a consumer to provide a voice pass phrase. The voice pass phrase is then sent as a candidate for voice identification to the retailer or the voice-key portal. The voice-key portal then provides the verbal identity code candidate to a biometric voiceprint engine to compare the proffered verbal identity code candidate with the saved voice pass phrase.

The comparison may be done using any standard voiceprint technique, such as word choice, bandwidth, mean frequency, body cavity resonance, pitch, shape of vowels, distribution of sound energy, pauses, stops, fricatives, plosives and so on. In particular, the use of word choice (the technology may use voice recognition technology) allows additional security features to be provided.

In use, the device security features extend beyond merely identifying verbal identity candidates as either passing or failing. For example, if the user has the correct vocal characteristics but provides the wrong words, it may be that the customer has simply forgotten their security words. However, if the correct words are being spoken by a voice which has different characteristics than that of the user, a fraud detection flag may be set. Or if the verbal identity candidate is exactly the same as the voice-key on file with the biometric voiceprint engine, then a flag indicating use of a probable audio recording may be set/raised/posted.

The portal of the voice-key system may also maintain customer financial data, in particular credit card number, credit card security codes and credit card billing address and credit card holder name, or in the alternative bank account number and routing number. However, in addition to these other financial data may be maintained, including but not limited to, shipping address for the aforementioned physical step of shipping the product, performance address for the aforementioned physical step of performing a service, and even other data which is financially valuable to retailers such as demographic data, electronic commerce history and so on.

Another unique aspect of the invention is the elimination of the need for a special purpose “set top box” or application. While the device of the invention may be used in the form of a JAVA® applet, or a cell phone app, a computer application and so on, it is not so limited. In particular, the invention offers the ability to add to a retailer's website a standardized XML/HTML ‘button’ akin to known types of intermediary payment buttons, but which button allows the customer to use the system without any extra effort of downloading an applet or the like. This can include built in browser features or protocols such as FLASH, Silverlight, and so on, or aspects of the operating system itself, such as iOS, Android and so on. The user may simply activate the ‘button’ and then the webpage activates the user's electronic browsing device microphone (the microphone on a computer, a tablet, a telephone, etc) to pick up the user's voice as they recite the voice-key.

These and many other aspects, objectives, embodiments and advantages of the present invention will be discussed further below. The above-discussed disadvantages of the reference art are overcome by the system and method of the present invention that provides a simple, yet elegant solution to quickly purchasing a specific product/service offered online without leaving the social network environment or having to enter payment information more than once during initial sign-up.

It is therefore yet another aspect, advantage, objective and embodiment of the invention to provide a method of electronic commerce offered by an electronic retailer, for use by a customer having an electronic browsing device, the method comprising the steps of:

providing a database having a plurality of records, each record associated with a single customer,

each record having commercial information associated with such customer;

each record having biometric voiceprint identity information associated with such customer;

each record having word choice identity information associated with such customer;

providing a product/service for purchase by such customer;

transmitting to such customer a purchase page;

offering such customer the option of voice checkout and proceeding with the following steps if the customer elects voice checkout

activating a microphone on such customer's electronic browsing device;

recording the customer's verbal identity code candidate;

transmitting the verbal identity code candidate to a voice checkout portal;

submitting the verbal identity code candidate to a biometric voiceprint engine for testing;

comparing words in the verbal identity code candidate to word choice identity information associated with such customer;

comparing biometric voiceprint information in the verbal identity code candidate to the biometric voiceprint identity information associated with such customer;

based upon the results of the comparisons of the verbal identity code candidate to the information associated with such customer, assigning a test outcome status to the verbal identity code candidate;

returning the test outcome status to such electronic retailer;

determining if the test outcome status is acceptable to such electronic retailer;

if the test outcome status is acceptable to such electronic retailer, completing a purchase, including providing the service/shipping the product;

if the test outcome status is not acceptable to such electronic retailer, determining if the test outcome status merits raising a fraud detection flag;

if the test outcome status does not merit raising a fraud detection flag, determining if such electronic retailer wishes to offer such customer a chance to retry the voice checkout and if so, returning to the step of offering such customer the option of voice checkout.

It is therefore yet another aspect, advantage, objective and embodiment of the invention to provide a method of electronic commerce wherein the step of providing a database having a plurality of records, further comprises:

providing an online commerce site;

providing a registration process in turn comprising the steps of:

offering to such customer the opportunity to register for voice checkout;

if such customer accepts the opportunity to register for voice checkout, creating the record associated with such customer;

obtaining from such customer the customer's commercial information and associating that commercial information with such customer in the record;

activating the microphone on such customer's electronic browsing device;

recording a pass phrase including both biometric voiceprint identity information and word choice identity information;

transmitting to the voice checkout portal the pass phrase;

submitting the pass phrase to the biometric voiceprint engine;

associating that information with such customer in the record, including associating the biometric voiceprint identity information and the word choice identity information with the customer.

It is therefore yet another aspect, advantage, objective and embodiment of the invention to provide a method of electronic commerce further comprising the step of associating an exact recording information of the pass phrase with such customer in the record, and wherein the step of comparing the biometric voiceprint information further comprises comparing exact audio recording information of the verbal identity code candidate to the exact audio recording information associated with the customer.

It is therefore yet another aspect, advantage, objective and embodiment of the invention to provide a method of electronic commerce wherein the test outcome status is one member selected from the group consisting of: a first status in which both words and voiceprint match, a second status in which there is no match, a third status in which there is an exact recorded match, a fourth status in which words only match, a fifth status in which the voice only matches, and combinations thereof.

It is therefore yet another aspect, advantage, objective and embodiment of the invention to provide a method of electronic commerce wherein the biometric voiceprint information further comprises: a complete record of the biometric voiceprint information, a hash of the biometric voiceprint information, compressed/encoded biometric voiceprint information, parity bit checking of the biometric voiceprint information, and combinations thereof.

It is therefore yet another aspect, advantage, objective and embodiment of the invention to provide a method of electronic commerce wherein the step of comparing biometric voiceprint information further comprises comparing one member selected from the group consisting of: word choice, bandwidth, mean frequency, body cavity resonance, pitch, shape of vowels, distribution of sound energy, pauses, stops, fricatives, plosives and combinations thereof.

It is therefore yet another aspect, advantage, objective and embodiment of the invention to provide a method of electronic commerce wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

It is therefore yet another aspect, advantage, objective and embodiment of the invention to provide a method of electronic commerce wherein the purchase page is encoded using one member selected from the group consisting of: XML, HTML, XHTML, JAVA, PHP, ASP.net, HTML5, FLASH, Silverlight, Quicktime, iOS, Android, a programming language now known or later developed and combinations thereof.

It is therefore yet another aspect, advantage, objective and embodiment of the invention to provide a method of electronic commerce wherein the transmissions of the method are carried out using one member selected from the group consisting of: the Internet, an intranet, closed garden protocols, voice transmissions and combinations thereof.

It is therefore yet another aspect, advantage, objective and embodiment of the invention to provide an electronic commerce portal for use by a customer having an electronic browsing device and an electronic retailer offering an electronic purchase page, the portal comprising:

a database having a plurality of records, each record associated with a single customer,

each record having commercial information associated with such customer;

each record having biometric voiceprint identity information associated with such customer;

each record having word choice identity information associated with such customer;

a purchase page module provided by the electronic commerce portal to such electronic retailer for insertion into a purchase page, the purchase page module operative to activate a microphone on such customer's electronic browsing device and record voice information; the purchase page module further operative to transmit such verbal identity code candidate to the electronic commerce portal;

the electronic commerce portal operative to submit the verbal identity code information to a biometric voiceprint engine;

the biometric voiceprint engine operative to receive a verbal identity code candidate and test it against such biometric voiceprint identity information and such word choice identity information;

a status determination module operative to receive from such biometric voiceprint engine the outcome of such test and assign a test outcome status to the verbal identity code candidate;

the modules of the portal written upon a non-volatile memory medium within at least one computer system.

It is therefore yet another aspect, advantage, objective and embodiment of the invention to provide an electronic commerce portal, further comprising:

a registration module operative to offer to such customer the opportunity to register for voice checkout; the registration module further operative to create the record associated with such customer, obtain from such customer the customer's commercial information and associating that commercial information with such customer in the record;

the registration module further operative to activate the microphone on such customer's electronic browsing device and record a pass phrase including both biometric voiceprint identity information and word choice identity information and then submit the pass phrase to the biometric voiceprint engine while associating that information with such customer in the record, including associating the biometric voiceprint identity information and the word choice identity information with the customer.

It is therefore yet another aspect, advantage, objective and embodiment of the invention to provide an electronic commerce portal, the registration module further operative to associate an exact recording information of the pass phrase with such customer in the record, the biometric voiceprint engine further operative to compare exact audio recording information of the verbal identity code candidate to the exact audio recording information associated with the customer.

It is therefore yet another aspect, advantage, objective and embodiment of the invention to provide an electronic commerce portal, wherein the test outcome status is one member selected from the group consisting of: a first status in which both words and voiceprint match, a second status in which there is no match, a third status in which there is an exact recorded match, a fourth status in which words only match, a fifth status in which the voice only matches, and combinations thereof.

It is therefore yet another aspect, advantage, objective and embodiment of the invention to provide an electronic commerce portal, wherein the biometric voiceprint information further comprises: a complete record of the biometric voiceprint information, a hash of the biometric voiceprint information, compressed/encoded biometric voiceprint information, parity bit checking of the biometric voiceprint information, and combinations thereof.

It is therefore yet another aspect, advantage, objective and embodiment of the invention to provide an electronic commerce portal, wherein the biometric voiceprint information further comprises one member selected from the group consisting of: word choice, bandwidth, mean frequency, body cavity resonance, pitch, shape of vowels, distribution of sound energy, pauses, stops, fricatives, plosives and combinations thereof.

It is therefore yet another aspect, advantage, objective and embodiment of the invention to provide an electronic commerce portal, wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

It is therefore yet another aspect, advantage, objective and embodiment of the invention to provide an electronic commerce portal, wherein the purchase page module is encoded using one member selected from the group consisting of: XML, HTML, XHTML, JAVA, PHP, ASP.net, HTML5, FLASH, Silverlight, Quicktime, iOS, Android, a programming language now known or later developed and combinations thereof.

It is therefore yet another aspect, advantage, objective and embodiment of the invention to provide an electronic commerce portal, wherein the transmissions of the method are carried out using one member selected from the group consisting of: the Internet, an intranet, closed garden protocols, voice transmissions and combinations thereof.

It is therefore yet another aspect, advantage, objective and embodiment of the invention to provide an electronic commerce portal, wherein the biometric voiceprint engine further comprises a neural net having a plurality of nodes, the nodes in turn organized into a plurality of layers including at least a first layer identifying identification points and a second layer identifying words.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a block diagram of a system and apparatus of the invention and the environment in which it might operate.

FIG. 2 is a flow chart of the registration operations of the system/apparatus and also of the method embodiment of the invention.

FIG. 3 is a flow chart of the purchase operations of the system/apparatus and also of the method embodiment of the invention.

FIG. 4 is a table of flags set by the invention to indicate to a retailer the testing outcome status of a customer attempt to use the system.

FIG. 5 is an exemplary spectrogram of a sound such as might be tested by the system.

FIG. 6 is an exemplary oscilloscope diagram to show the difference between a spectrogram, which might be part of a preferred embodiment of the invention, and a more-commonly-seen but unlikely-to-be-used oscilloscope-type display of audio information.

FIG. 7 is a simplified block diagram of an individual customer record according to the invention.

FIG. 8 is a simplified exemplary spectrogram showing the use of the identification points as they are provided as input to an expert system.

FIG. 9 is an exemplary spectrogram and neural network identification system.

### INDEX TO THE REFERENCE NUMERALS

Network 100
Portal 102
Voice recognition engine 104
Word recognition & database module 106
Voice recognition & database module 108
Electronic Service/Retailer 110
Checkout page (XML, etc) 112
Consumer/Buyer 114
Browser (supports XML, etc) 116
Physical transfer of item/perform service 118
Registration offer from retailer/portal 200
Consumer decision 202
Request voice identity code (words, voice) 204
Activate microphone 206
Return voice identity code to retailer 208
Return voice identity code to portal 210
Direct voice identity code to VR engine 212
Database words and voiceprint associated with consumer identity 214
Pre-purchase activity (shopping) 300
Transmission of purchase page (HTML, XML, JAVA, FLASH, etc) 302
Consumer choice 304
Turn on microphone 306
Record verbal identity code candidate 308
Transmit candidate code to retailer 310
Forward candidate code to portal 312
Submit candidate code to engine for testing 314
Compare words to words associated with customer identity 316
Compare biometric voiceprint to voiceprint associated with customer identity 318
Compare audio recording to audio recording associated with customer identity 320
Determine test outcome, flag status 1-5 322
Return status to portal 324
Return status to retailer 326
Status is acceptable to retailer? 328
Complete transaction 330
Offer retry 332
Words and voice match, status 1 400
No match, status 2 402
EXACT (recorded) match, status 3 404
Only voice match, status 4 406
Only words match, status 5 408
Other statuses, status 6+ 410
spectrogram 500
identification point 502
vertical time axis 504
horizontal frequency axis 506
oscilloscope display 600
record 700
customer name 702
recording of registration 704
biometric voiceprint id information 706
word choice information 708
status flags 710-720
word choice 722
bandwidth 724
mean frequency 726
body cavity resonance 728
pitch 730
shape of vowels 732
distribution of sound energy 734
pauses 736
stops 738
fricatives 740
plosives 742
credit card number 744
credit card security codes 746
credit card billing address 748
credit card name 750
bank account number 752
bank routing number 754
other financial data 756
shipping address 758
performance address 760
demographic data 762
spectrogram 800
feature/identification point 802
feature/identification point 804
expert system 806
spectrogram 900
feature/identification point 902
feature/identification point 904
feature layer 906
phoneme layer 908
word layer 910
neural node 912

### DETAILED DESCRIPTION OF EMBODIMENTS

Briefly and in general terms the present invention provides a system that facilitates online purchase transactions within social network environments by enabling online consumers to checkout quicker and more easily through a simply posting to their profile page, newsfeed, or status update. The system includes a search engine and a payment processing component. The search engine monitors the posts on one or more social networks in search of particular strings of characters that indicates a social network user's intent to purchase a product. The search engine may be limited to monitoring a particular group of users or all users on a social network. For example, the search engine may limit itself to monitoring the accounts of social network users that receive an offer message from an online merchant user account or to the followers, connections, or friends of a merchant that posts an offer.

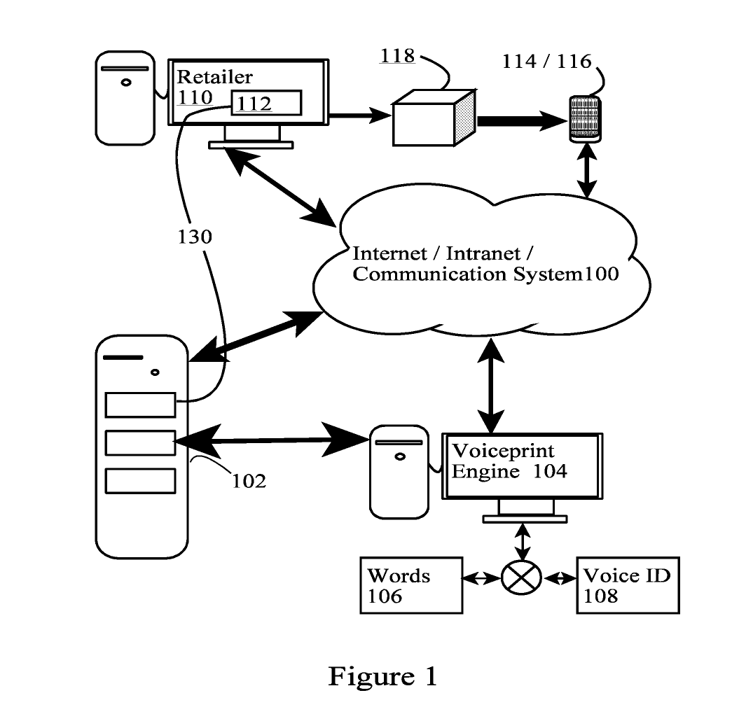

FIG. 1 is a block diagram of a system and apparatus of the invention and the environment in which it might operate.

Network 100 may in preferred embodiments and the best mode now contemplated be the Internet, however, it may also be an intranet, a private network, either a physical network or a network which is actually comprised of communication protocols or codes not open to the general public (all such systems are included in the term “closed garden” as used herein), a telephone network and so on.

Portal 102 is the intermediary service which provides the voice-keyed payment option to both retailers and customers. Portal 102 serves the function of a commercial enterprise, offering electronic retailers of goods and services the intermediary service of payment verification by means of voice-key technology. Note that in alternative embodiments the portal may be eliminated and the electronic retailers may use the service for their own customer base and with their own voice recognition/voiceprint engine and database.

Voice recognition engine 104 contains at a minimum its own voiceprint and voice recognition algorithms and modules, and in addition contains word recognition & database module 106 and voice recognition & database module 108.

For the present application, the term voiceprint and the term voice recognition are not synonymous.

Voice recognition (VR) in the present application means the ability to hear a human voice speak and from that voice determine the word or words that were spoken. This capability allows an extra layer of security to be added to the invention, in a pseudo-multi-modal framework.

Voiceprint technology on the other hand refers to the ability to identify, exactly, a particular voice as being that of a particular person. This is the basic identification ability used in the present invention, albeit supplemented as discussed elsewhere.

Electronic service/retailer 110 may purvey physical goods (books, clothing, electronics and so on), electronic goods (video, music, etc), services either physical or online (a maid service, accounting, etc). Sales/purchases made may be actual sales of title in goods, or may be contracts for services, licenses to playing of entertainment and so on. The crucial fact is that the retailer 110 has an online shopping presence which includes a checkout page (in HTML, XML, etc) 112. At this checkout page the customer is presented with an electronic point-of-sale and money actually changes hands, being transferred from one credit account or bank account to another. This transfer of money, which may be represented by cash, can in fact include within the scope of the invention the physical transfer of cash money by electronic means and withdrawal.

One additional step within the scope of the invention may be the transfer of money, followed by that withdrawal, thus effecting the physical moving of money.

Consumer/Buyer 114 might more accurately be represented by their electronic browsing device: a smart telephone, a tablet, a computer, or even a dumb telephone terminal.

Browser 116 supports common page transfer protocols such as HTML, XML, XHTML, JAVA and the like, by which means webpages may be easily displayed on the electronic browsing device 114.

Physical transfer of item/perform service/transfer of money 118 is seen to occur outside of the electronic context, that is, the present invention results in the transfer of tangible physical items such as diamonds, tires, etc.

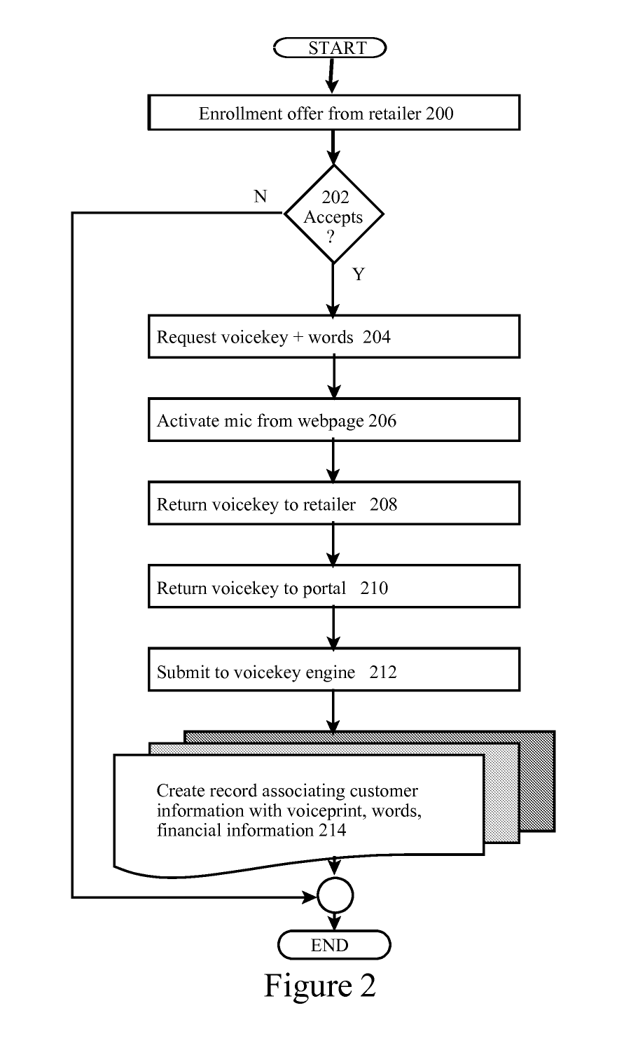

FIG. 2 is a flow chart of the registration operations of the system/apparatus and also of the method embodiment of the invention. This is an optional step in the invention, as the database may be assembled by means other than individualized registration, however, the preferred embodiment and best mode now contemplated is a registration offer from retailer or portal, as seen at step 200. Consumer decision to register 202 initiates the process.

The first step thereafter is a request for a voice identity code (including both choice of words, and voice), step 204. For typical purposes, such a voice identity code may be quite short, however, a tradeoff between security and convenience ensues, as the word “the” or “and” alone would be unlikely to provide much security, while a recitation of a long poem would likely lead to memory errors, not to mention wasted digital capacity in terms of electronic bandwidth or storage or processing. Thus, a typical range of words for the pass phrase might be from 10 to 20 words, with more or fewer easily possible. The registering new user will have these issues explained in brief before being urged to think of a pass phrase which will always come easily to memory and lips.

Activation of the customer's microphone at step 206 is followed by the recording of the pass phrase for the first time. This is then returned as a voice identity code to the retailer 208 or directly returned as a voice identity code to the portal 210, or via the retailer to the portal.

The portal may then enter the voice identity code, unprocessed or processed, into a portal database, for example as a security and pass phrase recovery feature. However, the main use of the new voice key/voice identity code is for further processing for identification purposes.

The new voice identity code is thus directed/submitted to the voiceprint/VR engine 212 which then processes it, choosing the marker points which help identify the customer, reducing the audio recording (likely to be a file in a format such as MP3, WAV, or other more modern formats now known or later devised) to a usable voiceprint data set, which is then stored in the database. These words and voiceprint are then associated with the consumer identity in the database, in step 214.

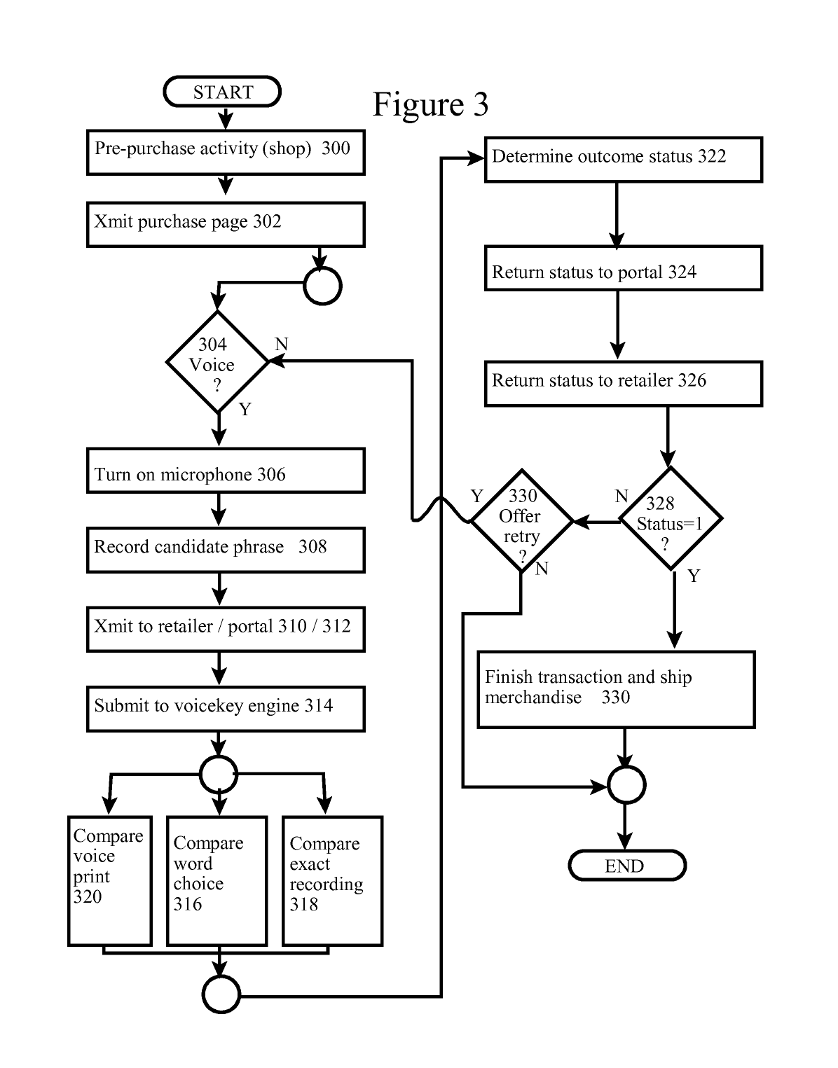

Turning now to a typical purchase, FIG. 3 is a flow chart of the purchase operations of the system/apparatus and also of the method embodiment of the invention.

Pre-purchase activity 300 is more or less shopping. When a purchase is requested by the consumer, the current invention is then invoked by the transmission of a purchase page, again in HTML, XML, JAVA, etc, at step 302. The purchase page may have embedded normally within it the code necessary to carry out a transaction, that is, it can activate a microphone, make a recording, etc. It may in less preferred embodiments have this embedded by addition of a downloaded app, applet, add-on, plug-in or the like.

Customer choice 304 is that step at which the customer makes an election to use the process of voice checkout. This invokes the routine to follow, in which the device turns on the microphone (step 306) and records the verbal identity code candidate at step 308. This then is transmitted either as shown, to the retailer (310) and thence to the portal at step 312 or directly to the portal.

This then submits 314 the candidate code to engine for testing.

Testing will normally have a minimum of one component (the comparison of biometric voiceprint to the voiceprint associated with the customer identity 318) but may have up to three, including as well the comparisons of words to words associated with the customer identity at step 316, and a comparison of audio recording (the candidate) to audio recording (the original registration) associated with customer identity at step 320. These steps are depicted concurrently but may be carried out in parallel.

The allows determination of a test outcome, which can be represented by a status flag one through five being set at step 322. The status of the testing is then returned to the portal at step 324 as shown, or else goes directly to the retailer. If it is sent through the portal the portal will then forward it to the retailer as shown at step 326.

The retailer, or more accurately the retailer's server system, will then encounter a decision: is the status is acceptable to the retailer? (Step 328). In general, only the flag indicating a successful voiceprint match will be acceptable but the retailer can make various determinations, for example, that a failure based on incorrect word choice will lead to an offer to retry the transaction (step 332) while a failure based upon use of a tape recording or the correct words but wrong voice will initiate an anti-fraud activity and so on.

If the status indicates a successful verification, then the next step is completion of the transaction 330, including the shipment of a product from the retailer to the customer, or the carrying out of a service activity.

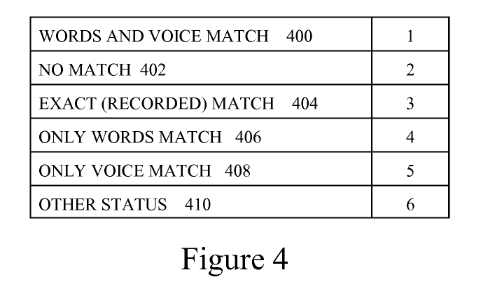

FIG. 4 is a table of flags set by the invention to indicate to a retailer the testing outcome status of a customer attempt to use the system.

Words and voice match, status 1, (400) indicates that both words and voice matched, a successful verification of the candidate input.

No match, status 2, (402) indicates a failure of the testing.

Exact (recorded) match, status 3 (404) could be an indication of fraud, as could status 5, in which only the words match (410).

On the other hand if only the voice matches, status 4 (406) a retailer might choose to interpret this as indicating that the customer has forgotten their voice-key.

Other statuses, status 6+ (410) are also possible in alternative embodiments.

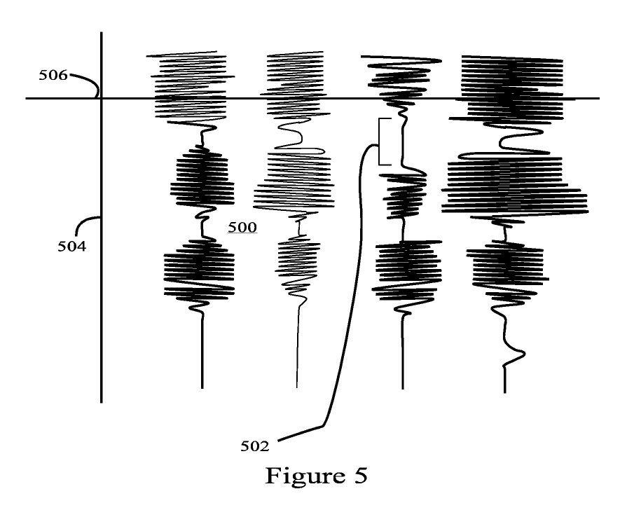

FIG. 5 is an exemplary spectrogram a sound such as might be tested by the system with a manual or automated verification embodiment. Obviously manual verification is a much less preferred for reasons of time and economics.

Spectrogram 500 has a typical identification point such as those listed previously. Identification point 502 may be part of a larger sound analysis made with a vertical time axis 504 and a horizontal frequency axis 506. The voiceprint engine might analyze such identification points in order to help ascertain the identity of a voice candidate.

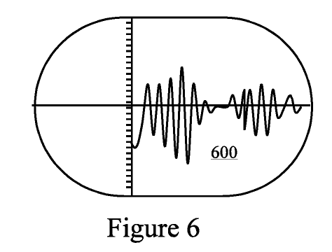

FIG. 6 is an exemplary oscilloscope diagram to show the difference between a spectrogram, which might be part of a preferred embodiment of the invention, and an oscilloscope-type display of audio information. Oscilloscope display 600 can be used for voice identification (amplitude vertical axis versus frequency horizontal axis) but it is less desirable.

Digital methods using advanced algorithms without any graphical display are the preferred embodiment, as such digital methods allow very fast voiceprint identification with minimal or no human oversight.

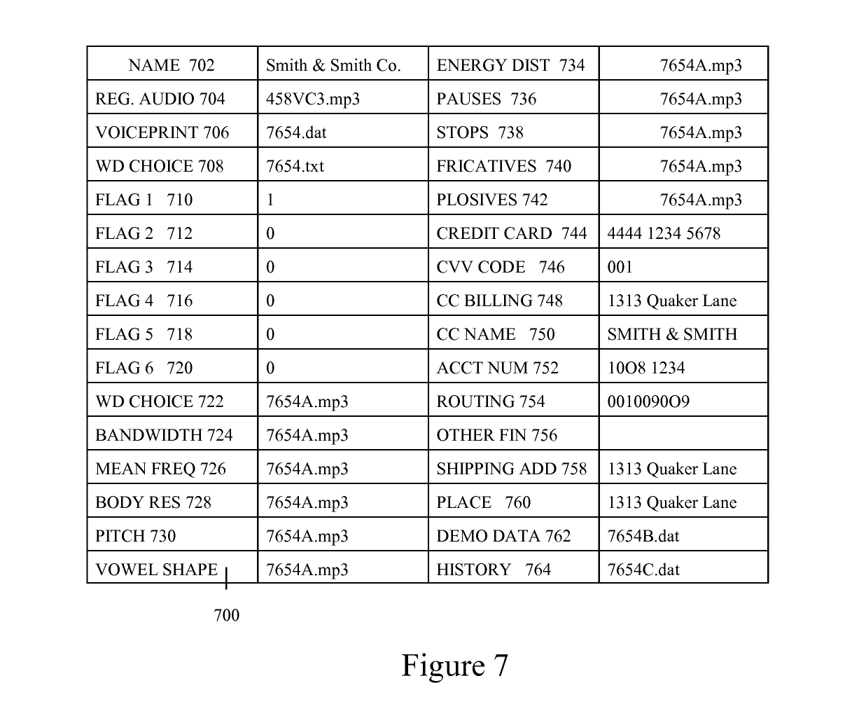

FIG. 7 is a simplified block diagram of an individual customer record according to the invention.

Record 700 has numerous individual fields of data therein. Customer name 702 may be a business name or an individual name, and may be broken up (first name, last name, etc). A check against fraud by use of digital or analog audio recordings of an individual's pass phrase may be conducted if a recording of the original voice registration 704 is maintained, note that this recording can be a complete recording, or it can be an encryption of a recording of the original registration, or a compacted or edited form thereof, such as a short snippet, a mathematical extraction therefrom, etc.

Biometric voiceprint id information 706 and word choice information 708 are fairly obvious components of the overall system. It is worth noting that in most economical systems the words used by the customer MUST be the same each time, that is, the word choice and voiceprint information are in fact inseparable. However, by means of voice recognition technology to sort out the exact words used, and by means of voiceprint technology which can identify a voice even when uttering words not heard by the system previously, it is possible to separate these. Since such separation is a desirable security feature, the use of more complicated systems which employ that is preferable.

Status flags 710-720 represent, among other things, the outcome of such a divided analysis. As noted previously in regard to FIG. 5, flag field 710 (status flag 1) may represent a match, flag field 712 (status flag 2) may represent no match, while 714 (status flag 3) may represent an exact match, suspected of being a recording. Flags 716 (flag 4) and 718 (status 5) may represent words matching or the voice matching—status flag 4 (716) in particular raising a suspicion of fraud—while flag 720 may represent yet another possible outcome of testing.

Word choice 722 may represent a data field containing text or code which indicates the exact wording of the pass phrase in human accessible format. This could be useful for password recovery functions and the like.

Bandwidth 724, mean frequency 726, body cavity resonance 728 (nasal passage resonance, lung resonance, etc), pitch 730, vowel shape 732, the overall distribution of vocal energy 734, the length, position and sound of pauses 736, stops 738, fricatives 740 and even plosives 742 are all other quantities customarily used in traditional voiceprint analysis, however, for purposes of the present application more accurate and more modern acoustic qualities may be used instead within the scope of the present invention.

Typical consumer financial data may include payment information, with the obvious fields for credit card number 744, credit card security codes 746, credit card billing address 748, and credit card name 750, as well as or in the alternative including bank account number 752, ABA bank routing number 754 and the like. Further financial data 756 may be stored as well.

While not normally considered “financial” data, for the purposes of electronic business other quantities of the customer are also financial data: the nature of their domicile (single family, multi-unit, commercial, retail, etc), whether they rent or own, location of physical shipping/performance and so on may be subsumed fairly easily with shipping address 758/performance address 760. In addition, this data can be combined to become of value to the company in the area of data mining, for example when combined with demographic data 762 and electronic commerce history 764.

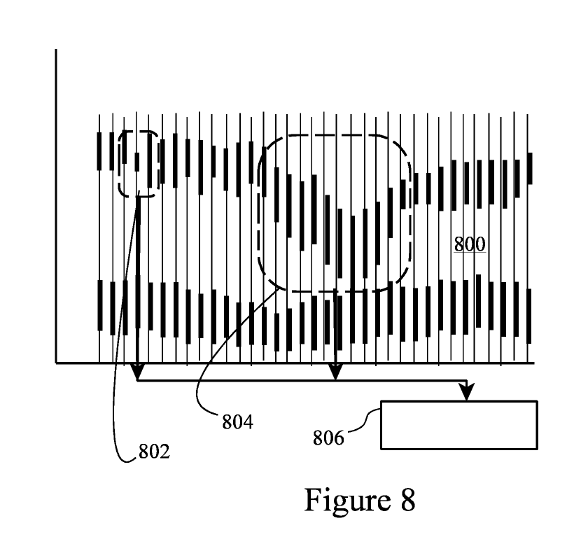

FIG. 8 is a simplified exemplary spectrogram showing the use of the identification points as they are provided as input to an expert system. Spectrogram 800 has several identification points, such as rises or dips in the overall shape during time (for example

feature/identification point 802) or a sharp drop in a particular frequency (for example feature/identification point 804). This information may be detected and provided to expert system 806, which is a voice recognition system.

Such VR systems are usually used for IVR systems, for example for consumer bill payments, however, the systems may also be used for security, as in the present invention. In addition, the expert system may be used for voice identification as well as voice recognition, thus providing an extra layer of security.

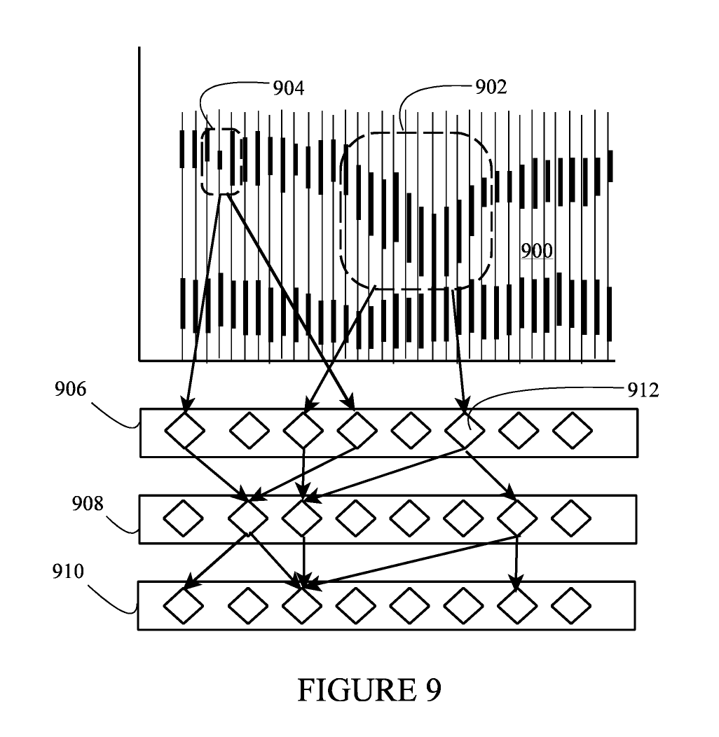

FIG. 9 is an exemplary spectrogram and neural network identification system. In this case the expert system of FIG. 8 is replaced by a more detailed diagram of a more sophisticated type of system.

Neural networks are considered to be one possible method of dealing with extremely fuzzy data sets which are normally too difficult for a standard computer to analyze. In particular, it has been found that voice recognition and voice identification are areas in which neural networks may be profitably employed. Such networks normally operate by having multiple layers of nodes which each have only a few inputs and outputs and very simple processing capabilities. When a signal reaches a given node, that node may analyze only a single aspect or characteristic of the signal.

Such networks achieve their highly effective results by providing a multiplicity of such nodes which all operate together in an arrangement both sequential and parallel. Thus, the signal goes to a first layer of the network, where several nodes recognize different aspects of it and based on their individually very simple analysis, in turn activate the appropriate nodes in the second layer. Since several nodes in the first layer are doing this at the same time, several nodes in the second layer are not activated and the process is repeated for the second layer nodes which were activated, which then send the signal to appropriate nodes of a third layer, based upon their own simply individualized analysis.

There may be more than three layers and in addition, while in this example the signal is seen passing through the system in only one direction, a node in the second layer can also activate a node in the first layer, in effect sending the signal backward briefly. Layers may be skipped and the signal strength of any given activation may be employed as another form of neural mimicry. The system may also feature recursion and feedback as well as adjustable node responses and may thus “teach” itself based on previous outcomes.

In the end, the final answer provided may be much more accurate than a single, algorithmic, analysis could have provided.

In FIG. 9, spectrogram 900 is seen to have various features, indicating fluctuations in the sound waves such as the general reduction of energy of feature/identification point 902 or the localized reduction of energy of feature/identification point 904.

The embodiment of FIG. 9 is similar to the TRACE system of language recognition, in that there are three layers (feature, phenome, and word) and the system uses the spectrogram for input.

Feature layer 906 accepts these features: some nodes are not activated, others are activated depending on the nature of the feature being analyzed. In turn these nodes have been trained or programmed, depending on the nature of the system, to activate certain other nodes in the phoneme layer 908. (A phoneme is a very small part of audible speech, for example, a phoneme might correspond to a single vowel sound.)

The phoneme layer 908 might then analyze the results in terms of phonemes and send the results to a word layer 910.

One neural node 912 is shown activated and receiving and input and determining which other nodes should then be activated based thereon.

It will be seen that one advantage of such a system is that if it has been programmed or trained to accept a particular user's voice, then it can not only sort out words but can also identify the fact that a later provided sound sample is not the correct user, and can do so as part of its normal operation in any case.

### EXAMPLE ONE

In this example steps and modules belonging to different diagrams are referred to in order of usage, rather than in numerical order.

An example of the use of the present invention might be a customer who ventures online 100 (using a tablet device 114 to browse the Internet) as the customer shops for an item of clothing. Thus, this would be an example of a sale of good to a consumer for personal use. The consumer locates the item that they wish to purchase at the electronic store of a retailer. The consumer adds the item to an electronic shopping cart and then moves on to a check-out page.

The retailer's check-out page 112 is of course actually downloaded 302 quickly and temporality to the temporary folders of the consumer computer, and it has embedded therein a piece of XML code which displays to the consumer several check-out options as soft buttons. Noting that the “Voice Checkout” button exists, the consumer selects the “Voice Checkout” button and the embedded code which is part of the check-out page 112 begins to operate. It indicates to the consumer that they should speak their verbal identification pass phrase 706, including the correct words 708, and it activates 300 the microphone of the table device 114 to record 308 the sound.

The recording, now a candidate for testing, may for additional security be hashed, encrypted, etc, and is then transmitted to the retailer 310, transmitted again 312 to the portal, and submitted 314 by the portal to the voiceprint identification engine 104. The engine 104 then runs three comparisons, comparison (via voice recognition) of word choice 316, of voiceprint 320, and in addition, it performs a check 318 to make sure that an audio recording (digital, analog, or by any mechanism) is not being employed.

The consumer has forgotten the correct wording in this case.

The engine 104 will then set a test outcome status flag 322 (and 710-720), or more than one flag, based on the test of the candidate sound. Assuming for the sake of the example that the test is failed, and that the voice matches but the words are incorrect, flag 5 is set. This status is returned to the portal 324 and thence to the retailer 326.

Retailer 326 may optionally have different responses coded. In steps 326 and 332, the retailer does not approve of the transaction but does offer the customer a retry, returning processing back to step 304. This time, the consumer remembers the correct words and the status flag returned is 1, indicating a match. At step 320 the processing continues to step 330 and the merchandise is shipped to the consumer.

### EXAMPLE TWO

In this example steps and modules belonging to different diagrams are referred to in order of usage, rather than in numerical order.

In this example a business person customer needs a temporary employee for inventory work and using their computer, locates an online temping agency and goes through the agency's website and determines that they wish to have the inventory worker assigned as soon as possible.

However at step 302, when the “Voice checkout” option is offered, the business person customer recognizes that they have never registered their business for voice checkout, and further realizes that voice checkout would be convenient. They select the option and are directed to the registration system. The system asks them for normal commercial information (company name, the location at which services are to be performed, credit card or banking information and so on) and then activates the microphone 206, returns 208 the recorded choice of words, in the voice of the customer, forwards the words to the portal (step 210, module 102), and then their information is properly associated in a new record 700. The complete recording may optionally be saved for testing in order to prevent the use of audio files to dupe the system, the customer's business name and other information may be stored in the database and so on. In addition voiceprint engine 104 receives the words and voice, returns the text version of the words (after VR) to record 700, field 722, stores the marker points which will be used to test future purchases, and processing stops.

At this point, the new customer is returned to the start of the purchase operation and procedures follow the general outline of the procedures of Example One above, with the caveat that the physical result is inventory servicing by a temporary employee who comes to the business person's address.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims. Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A method of electronic commerce offered by an electronic retailer, for use by a customer having an electronic browsing device, the method comprising the steps of:
providing a database having a plurality of records, each record associated with a single customer,
each record having commercial information associated with such customer;
each record having biometric voiceprint identity information associated with such customer;
each record having word choice identity information associated with such customer;
providing a product/service for purchase by such customer;
transmitting to such customer a purchase page;
offering such customer the option of voice checkout and proceeding with the following steps if the customer elects voice checkout
activating a microphone on such customer's electronic browsing device;
recording the customer's verbal identity code candidate;
transmitting the verbal identity code candidate to a voice checkout portal;
submitting the verbal identity code candidate to a biometric voiceprint engine for testing;
comparing words in the verbal identity code candidate to word choice identity information associated with such customer;
comparing biometric voiceprint information in the verbal identity code candidate to the biometric voiceprint identity information associated with such customer;
based upon the results of the comparisons of the verbal identity code candidate to the information associated with such customer, assigning a test outcome status to the verbal identity code candidate;
returning the test outcome status to such electronic retailer;
determining if the test outcome status is acceptable to such electronic retailer;
if the test outcome status is acceptable to such electronic retailer, completing a purchase, including providing the service/shipping the product;
if the test outcome status is not acceptable to such electronic retailer, determining if the test outcome status merits raising a fraud detection flag;
if the test outcome status does not merit raising a fraud detection flag, determining if such electronic retailer wishes to offer such customer a chance to retry the voice checkout and if so, returning to the step of offering such customer the option of voice checkout.

2. The method of online commerce of claim 1, wherein the step of providing a database having a plurality of records, further comprises:
providing an online commerce site;
providing a registration process in turn comprising the steps of:
offering to such customer the opportunity to register for voice checkout;
if such customer accepts the opportunity to register for voice checkout, creating the record associated with such customer;
obtaining from such customer the customer's commercial information and associating that commercial information with such customer in the record;
activating the microphone on such customer's electronic browsing device;
recording a pass phrase including both biometric voiceprint identity information and word choice identity information;
transmitting to the voice checkout portal the pass phrase;
submitting the pass phrase to the biometric voiceprint engine;
associating that information with such customer in the record, including associating the biometric voiceprint identity information and the word choice identity information with the customer.

3. The method of online commerce of claim 2, further comprising the step of associating an exact recording information of the pass phrase with such customer in the record, and wherein the step of comparing the biometric voiceprint information further comprises comparing exact audio recording information of the verbal identity code candidate to the exact audio recording information associated with the customer.

4. The method of online commerce of claim 3, wherein the test outcome status is one member selected from the group consisting of: a first status in which both words and voiceprint match, a second status in which there is no match, a third status in which there is an exact recorded match, a fourth status in which words only match, a fifth status in which the voice only matches, and combinations thereof.

5. The method of online commerce of claim 1, wherein the biometric voiceprint information further comprises: a complete record of the biometric voiceprint information, a hash of the biometric voiceprint information, compressed/encoded biometric voiceprint information, parity bit checking of the biometric voiceprint information, and combinations thereof.

6. The method of online commerce of claim 1, wherein the step of comparing biometric voiceprint information further comprises comparing one member selected from the group consisting of: word choice, bandwidth, mean frequency, body cavity resonance, pitch, shape of vowels, distribution of sound energy, pauses, stops, fricatives, plosives and combinations thereof.

7. The method of online commerce of claim 1, wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

8. The method of online commerce of claim 1, wherein the purchase page is encoded using one member selected from the group consisting of: XML, HTML, XHTML, JAVA, PHP, ASP.net, HTML5, FLASH, Silverlight, Quicktime, iOS, Android, a programming language now known or later developed and combinations thereof.

9. The method of online commerce of claim 1, wherein the transmissions of the method are carried out using one member selected from the group consisting of: the Internet, an intranet, ‘closed garden’ protocols, voice transmissions and combinations thereof.

10. An electronic commerce portal for use by a customer having an electronic browsing device and an electronic retailer offering an electronic purchase page, the portal comprising:
a database having a plurality of records, each record associated with a single customer, each record having commercial information associated with such customer;
each record having biometric voiceprint identity information associated with such customer;
each record having word choice identity information associated with such customer;
a purchase page module provided by the electronic commerce portal to such electronic retailer for insertion into a purchase page, the purchase page module operative to activate a microphone on such customer's electronic browsing device and record voice information; the purchase page module further operative to transmit such verbal identity code candidate to the electronic commerce portal;
the electronic commerce portal operative to submit the verbal identity code information to a biometric voiceprint engine;
the biometric voiceprint engine operative to receive a verbal identity code candidate and test it against such biometric voiceprint identity information and such word choice identity information;
a status determination module operative to receive from such biometric voiceprint engine the outcome of such test and assign a test outcome status to the verbal identity code candidate;
the modules of the portal written upon a non-volatile memory medium within at least one computer system.

11. The electronic commerce portal of claim 10, further comprising:
a registration module operative to offer to such customer the opportunity to register for voice checkout; the registration module further operative to create the record associated with such customer, obtain from such customer the customer's commercial information and associating that commercial information with such customer in the record;
the registration module further operative to activate the microphone on such customer's electronic browsing device and record a pass phrase including both biometric voiceprint identity information and word choice identity information and then submit the pass phrase to the biometric voiceprint engine while associating that information with such customer in the record, including associating the biometric voiceprint identity information and the word choice identity information with the customer.

12. The electronic commerce portal of claim 11, the registration module further operative to associate an exact recording information of the pass phrase with such customer in the record, the biometric voiceprint engine further operative to compare exact audio recording information of the verbal identity code candidate to the exact audio recording information associated with the customer.

13. The electronic commerce portal of claim 12, wherein the test outcome status is one member selected from the group consisting of: a first status in which both words and voiceprint match, a second status in which there is no match, a third status in which there is an exact recorded match, a fourth status in which words only match, a fifth status in which the voice only matches, and combinations thereof.

14. The electronic commerce portal of claim 10, wherein the biometric voiceprint information further comprises: a complete record of the biometric voiceprint information, a hash of the biometric voiceprint information, compressed/encoded biometric voiceprint information, parity bit checking of the biometric voiceprint information, and combinations thereof.

15. The electronic commerce portal of claim 10, wherein the biometric voiceprint information further comprises one member selected from the group consisting of: word choice, bandwidth, mean frequency, body cavity resonance, pitch, shape of vowels, distribution of sound energy, pauses, stops, fricatives, plosives and combinations thereof.

16. The electronic commerce portal of claim 10, wherein the commercial information associated with a customer further comprises one member selected from the group consisting of: credit card number, credit card security codes, credit card billing address, credit card name, bank account number and routing number, other financial data, shipping address for the aforementioned physical step of shipping the product, performance address for the aforementioned physical step of performing a service, demographic data, electronic commerce history and combinations thereof.

17. The electronic commerce portal of claim 10, wherein the purchase page module is encoded using one member selected from the group consisting of: XML, HTML, XHTML, JAVA, PHP, ASP.net, HTML5, FLASH, Silverlight, Quicktime, iOS, Android, a programming language now known or later developed and combinations thereof.

18. The electronic commerce portal of claim 10, wherein the transmissions of the method are carried out using one member selected from the group consisting of: the Internet, an intranet, closed garden protocols, voice transmissions and combinations thereof.

19. The electronic commerce portal of claim 10, wherein the biometric voiceprint engine further comprises a neural net having a plurality of nodes, the nodes in turn organized into a plurality of layers including at least a first layer identifying identification points and a second layer identifying words.
